(19) United States
(12) Patent Application Publication
(10) Pub. No.: US 2021/0049718 A1
(43) Pub. Date: Feb. 18, 2021

(54) INFORMATION PROCESSING APPARATUS, VEHICLE, INFORMATION PROCESSING SYSTEM, INFORMATION PROCESSING METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Ryuichi KAMAGA, Nisshin-shi (JP); Kouki MORIYA, Nagakute-shi (JP); Yui OGURA, Nagoya-shi (JP); Shintaro MATSUTANI, Kariya-shi (JP)

(73) Assignee: TOYOTA JIDOSHA KABUSHIKI KAISHA, Toyota-shi (JP)

(21) Appl. No.: 16/989,082

(22) Filed: Aug. 10, 2020

(30) Foreign Application Priority Data
Aug. 13, 2019 (JP) 2019-148598

(51) Int. Cl. G06Q 50/20; G01C 21/34; G06Q 10/10

(52) U.S. Cl. CPC G06Q 50/205; G09B 19/00; G06Q 10/1095; G01C 21/3438

(57) ABSTRACT

An information processing apparatus includes a controller. The controller acquires holding information on a cooking class to be held in a vehicle and reception information on a receiving party who is to be provided with a deliverable obtained in the cooking class. The controller executes matching between the cooking class and the receiving party based on the holding information and the reception information that are acquired, and determines provision information to be notified to the receiving party according to a result of the matching.

### CROSS-REFERENCE TO RELATED APPLICATION

This application claims priority to and the benefit of Japanese Patent Application No. 2019-148598, filed on Aug. 13, 2019, the entire contents of which are incorporated herein by reference.

### TECHNICAL FIELD

The present disclosure relates to an information processing apparatus, a vehicle, an information processing system, an information processing method, and a program.

### BACKGROUND

Cooking classes held among an instructor and a student at a predetermined date and time, and at a predetermined location equipped with cooking facilities, are known. In such cooking classes, the instructor and the student gather at the predetermined date and time at the predetermined location, and then cooking instructions are given by the instructor to the student, using the cooking facilities with which the location is equipped. For example, a dish cooked by the student while receiving the cooking instructions from the instructor is sampled by the instructor and the student as a deliverable.

Systems for providing a customer with a cooking service using, unlike the cooking class, a moving vehicle are known. For example, Patent Literature (PTL) 1 discloses an on-site cooking service system which is characterized by loading ingredients onto a vehicle equipped with cooking facilities, traveling to the customer's location, and cooking the ingredients brought in, using the cooking facilities in the vehicle, to provide a cooked dish at the customer's location.

### CITATION LIST

### Patent Literature

PTL 1: JP 2001-199274 A

### SUMMARY

In the conventional cooking class, the deliverable obtained in the cooking class is consumed only in the cooking class, for example, by the instructor and the student of the cooking class. In such a case, assuming that a large quantity of deliverables are produced in the cooking class, the deliverables may not be completely consumed all by the instructor and the student. Therefore, a deliverable could be provided to a receiving party other than the instructor or the student in the cooking class, so that the deliverable is not discarded wastefully. However, in the conventional cooking class, the location and the date and time at which the class is held are predetermined to some extent, thus largely limiting the provision location and the provision date and time at which the deliverable is to be provided to the receiving party. Accordingly, the potential for matching between the cooking class and the receiving party is low, and thus a mechanism for providing the deliverable to the receiving party would not have been effective.

In addition, in the on-site cooking service system disclosed in the PTL 1, the vehicle equipped with the cooking facilities moves to the customer's location to thereby relax the limitations on the location and the date and time at which the cooking service is received. However, providing a deliverable from a cooking class held among an instructor and a student is not considered.

It would therefore be helpful to enable effective provision of a deliverable obtained in a cooking class to a receiving party.

An information processing apparatus according to an embodiment of the present disclosure includes a controller configured to:

acquire holding information on a cooking class to be held in a vehicle and reception information on a receiving party who is to be provided with a deliverable obtained in the cooking class;

execute matching between the cooking class and the receiving party based on the holding information and the reception information that are acquired; and

determine provision information to be notified to the receiving party according to a result of the matching.

An information processing method executed by an information processing apparatus according to an embodiment of the present disclosure includes:

acquiring holding information on a cooking class to be held in a vehicle;

acquiring reception information on a receiving party who is to be provided with a deliverable obtained in the cooking class;

executing matching between the cooking class and the receiving party based on the holding information and the reception information that are acquired; and

determining provision information to be notified to the receiving party according to a result of the matching.

A program according to an embodiment of the present disclosure causes an information processing apparatus to execute:

acquiring holding information on a cooking class to be held in a vehicle;

acquiring reception information on a receiving party who is to be provided with a deliverable obtained in the cooking class;

executing matching between the cooking class and the receiving party based on the holding information and the reception information that are acquired; and

determining provision information to be notified to the receiving party according to a result of the matching.

An information processing apparatus, a vehicle, an information processing system, an information processing method, and a program according to an embodiment of the present disclosure enables effective provision of a deliverable obtained in a cooking class to a receiving party.

### BRIEF DESCRIPTION OF THE DRAWINGS

In the accompanying drawings:

FIG. 1 is a configuration diagram illustrating a configuration of an information processing system including an information processing apparatus according to an embodiment of the present disclosure;

FIG. 2 is a functional block diagram illustrating a schematic configuration of a first terminal apparatus in FIG. 1;

FIG. 3 is a functional block diagram illustrating a schematic configuration of a second terminal apparatus in FIG. 1;

FIG. 4 is a functional block diagram illustrating a schematic configuration of a vehicle in FIG. 1;

FIG. 5 is a functional block diagram illustrating a schematic configuration of the information processing apparatus in FIG. 1;

FIG. 6 is a diagram for explaining matching between a cooking class and a receiving party;

FIG. 7 is a flowchart for explaining a first example of an information processing method executed by the information processing apparatus in FIG. 1;

FIG. 8 is a flowchart for explaining a second example of the information processing method executed by the information processing apparatus in FIG. 1;

FIG. 9 is a flowchart for explaining a third example of the information processing method executed by the information processing apparatus in FIG. 1;

FIG. 10 is a flowchart for explaining a fourth example of the information processing method executed by the information processing apparatus in FIG. 1;

FIG. 11 is a flowchart for explaining a fifth example of the information processing method executed by the information processing apparatus in FIG. 1;

FIG. 12 is a flowchart for explaining a sixth example of the information processing method executed by the information processing apparatus in FIG. 1; and

FIG. 13 is a flowchart for explaining a seventh example of the information processing method executed by the information processing apparatus in FIG. 1.

### DETAILED DESCRIPTION

An embodiment of the present disclosure will be described below, with reference to the drawings.

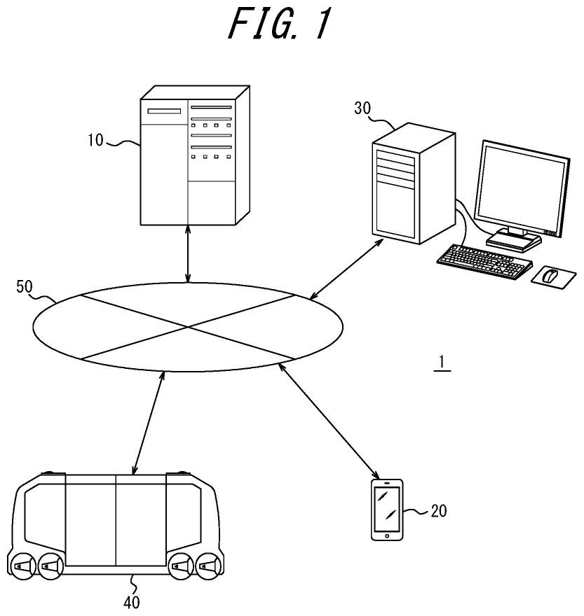

FIG. 1 is a configuration diagram illustrating a configuration of an information processing system 1 that includes an information processing apparatus 10 according to an embodiment of the present disclosure. Referring to FIG. 1, an outline of the information processing system 1 that includes the information processing apparatus 10 according to the embodiment of the present disclosure will be primarily described. In addition to the information processing apparatus 10, the information processing system 1 includes a first terminal apparatus 20 and a second terminal apparatus 30. For the sake of simplicity, FIG. 1 illustrates one of each of the first terminal apparatus 20, the second terminal apparatus 30, and a vehicle 40, but the number of first terminal apparatuses 20 and second terminal apparatuses 30 included in the information processing system 1, and vehicles 40 may be two or more.

Each of the information processing apparatus 10, the first terminal apparatus 20, and the second terminal apparatus 30 is connected to a network 50 that includes, for example, a mobile communication network, the Internet, and the like, together with the vehicle 40, in which a cooking class is held, so as to communicate with each other. At least part of the information processing system 1 is used for providing a mobility service (MaaS: Mobility as a Service). Each service provider can provide a mobility service such as a mobile cooking class, by using the vehicle 40.

The information processing apparatus 10 is a single server apparatus or a plurality of server apparatuses that can communicate with each other.

The information processing apparatus 10 is not limited to these, and may be any general purpose electronic device such as a personal computer (PC) or a smart phone, or may be any other electronic device that is dedicated to the information processing system 1.

The first terminal apparatus 20 is, for example, a general purpose electronic device such as a smart phone or a PC. The first terminal apparatus 20 is, for example, an electronic device used by a receiving party who is to be provided with a deliverable from the cooking class held in the vehicle 40. The first terminal apparatus 20 is not limited to these, and may be an electronic device that is dedicated to the information processing system 1.

The second terminal apparatus 30 is, for example, a general purpose electronic device such as a PC or a smart phone. The second terminal apparatus 30 is, for example, an electronic device used by a member of staff of an operating company that operates the cooking class held in the vehicle 40. The second terminal apparatus 30 is not limited to these, and may be a single server apparatus used by the operating company, or a plurality of server apparatuses used by the operating company that can communicate with each other, or may be an electronic device that is dedicated to the information processing system 1.

The vehicle 40 is, for example, an automobile. The vehicle 40 is not limited to this, and may be any vehicle that a person can board to hold the cooking class in the vehicle 40. While the cooking class is held, the vehicle 40 may move to a provision location, which will be described later, or may be stopped. The vehicle 40 is, for example, a vehicle that performs automated driving. The automated driving may include any level from Level 1 to Level 5 as defined by the Society of Automotive Engineers (SAE), for example, but is not limited to these, and may be defined in any way. The vehicle 40 is not limited to a vehicle that performs automated driving, and may be any vehicle driven by a driver.

As an outline of an embodiment, the information processing apparatus 10 acquires holding information on each cooking class to be held in the vehicle 40. In this specification, “holding information” means, for example, a holding area, a start date and time, an end date and time, a food and/or a beverage to be the theme, and the like. The information processing apparatus 10 acquires reception information on each receiving party who is to be provided with a deliverable obtained in a corresponding cooking class. In this specification, “deliverable” means, for example, a food and/or a beverage made by a student while receiving cooking instructions from an instructor in a cooking class. The term “reception information” means, for example, a reception location, a reception date and time, a food and/or a beverage, and the like that are desired by a receiving party. The information processing apparatus 10 executes matching between a cooking class and a receiving party based on the holding information and the reception information that are acquired, and determines provision information to be notified to the receiving party according to the result of the matching. In this specification, “matching” means determining a certain cooking class and a certain receiving party on which the holding information and the reception information conform to each other, from a plurality of cooking classes and a plurality of receiving parties, respectively. The term “provision information” means, for example, a provision location, a provision date and time, a food and/or a beverage, and the like regarding provision of a deliverable.

In this manner, according to an embodiment, since the vehicle 40 is used for holding a cooking class and providing a deliverable, the provision location and the provision date and time at which the deliverable is to be provided can be easily adjusted depending on the moving time and the moving place of the vehicle 40. That is, the limitations on the provision location and the provision date and time at which the deliverable is to be provided to a receiving party are sufficiently relaxed, and thus the potential for matching between the cooking class and the receiving party is improved. As a result, the mechanism for providing the deliverable to the receiving party becomes effective with respect to the cooking class held in the vehicle 40.

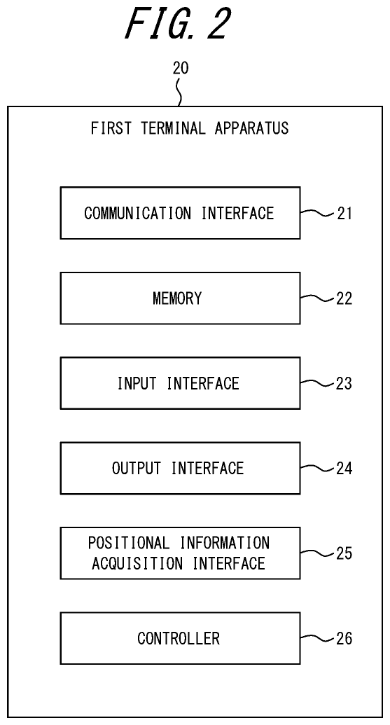

Next, referring to FIG. 2, a configuration of the first terminal apparatus 20 included in the information processing system 1 will be primarily described. FIG. 2 is a functional block diagram illustrating a schematic configuration of the first terminal apparatus 20 in FIG. 1.

As illustrated in FIG. 2, the first terminal apparatus 20 includes a communication interface 21, a memory 22, an input interface 23, an output interface 24, a positional information acquisition interface 25, and a controller 26.

The communication interface 21 includes a communication module connected to the network 50. For example, the communication interface 21 may include a communication module compliant with mobile communication standards such as the 4th generation (4G) and the 5th generation (5G) standards. In an embodiment, the first terminal apparatus 20 is connected to the network 50 via the communication interface 21. The communication interface 21 transmits and receives various information via the network 50.

The memory 22 is, for example, a semi-conductor memory, a magnetic memory, an optical memory, or the like, but is not limited to these. The memory 22 may function as, for example, a main memory, an auxiliary memory, or a cache memory. The memory 22 stores any information used in operation of the first terminal apparatus 20. For example, the memory 22 may store a system program, an application program, various types of information received by the communication interface 21, and the like. Information stored in the memory 22 may be updated with, for example, information received from the network 50 via the communication interface 21.

The input interface 23 includes at least one input interface for detecting user input to acquire input information based on an operation by a user. The input interface 23 is, for example, a physical key, a capacitive key, a touch screen integrally provided with a display of the output interface 24, a microphone for receiving audio input, or the like, but is not limited to these.

The output interface 24 includes at least one output interface for outputting information to notify the user of the information. The output interface 24 is, for example, a display for outputting the information in the form of an image, a speaker for outputting the information in the form of audio, or the like, but is not limited to these.

The positional information acquisition interface 25 includes at least one receiver compliant with a satellite positioning system. For example, the positional information acquisition interface 25 may include a Global Positioning System (GPS) receiver. The positional information acquisition interface 25 acquires a measured value of the position of the first terminal apparatus 20 as positional information. The positional information includes, for example, an address, a latitude, a longitude, an altitude, and the like. The positional information acquisition interface 25 may continuously acquire, or may periodically or non-periodically acquire the positional information for the first terminal apparatus 20.

The controller 26 includes at least one processor. The “processor” is a general purpose processor or a dedicated processor that is dedicated to specific processing in an embodiment but is not limited to these. The controller 26 is connected to each component included in the first terminal apparatus 20 so as to communicate with each component, and controls the operation of the entire first terminal apparatus 20.

When the input interface 23 detects an operation by the user as a receiving party who requests registration of reception information, the controller 26 displays an input screen indicating items required for registration of the reception information, using the output interface 24. The items required for registration of the reception information include, for example, items such as a reception location, a reception date and time, and a food and/or a beverage that are desired by the receiving party. The controller 26 acquires input information regarding these items that the receiving party inputs by operating the input interface 23. The controller 26 transmits the acquired input information as the reception information to the information processing apparatus 10 via the communication interface 21 and the network 50.

The controller 26 receives, from the information processing apparatus 10 via the network 50 and the communication interface 21, provision information according to a result of matching between a cooking class and a receiving party executed by the information processing apparatus 10. The receiving party understands the food and/or beverage provided by the cooking class, the provision location, the provision date and time, and the like, from the provision information notified by the first terminal apparatus 20. The receiving party receives a deliverable from the vehicle 40, which is navigated to the provision location, at the notified provision location at the notified provision date and time.

For example, when the input interface 23 detects an operation by the user as a receiving party who requests an evaluation of an instructor or a student regarding a deliverable provided from a cooking class, the controller 26 displays an input screen indicating items required for the evaluation of the instructor or the student, using the output interface 24. The items required for the evaluation include, for example, items such as an evaluation target selected from among the instructor and the student, an evaluation index such as a rank and a score of the selected evaluation target, and an evaluation comment on the evaluation target. The controller 26 acquires input information regarding these items that the receiving party inputs by operating the input interface 23. The controller 26 transmits the acquired input information as evaluation information indicating the result of the evaluation by the receiving party of another person from among the instructor and the student of the cooking class and the receiving party, to the information processing apparatus 10 via the communication interface 21 and the network 50.

In this specification, “evaluation information” means, for example, an evaluation target, an evaluation index such as a rank and a score of the evaluation target, an evaluation comment on the evaluation target, and the like. The term “student evaluation information” means evaluation information indicating a result of an evaluation of a student of a cooking class by an instructor of the cooking class or a receiving party. For example, “student evaluation information” means evaluation information or the like indicating a result of an evaluation of a student of a cooking class by an instructor of the cooking class or a receiving party, regarding cooking in the cooking class. The term “instructor evaluation information” means evaluation information indicating a result of an evaluation of an instructor of a cooking class by a student of the cooking class or a receiving party. For example, “instructor evaluation information” means evaluation information or the like indicating a result of an evaluation of an instructor of a cooking class by a student of the cooking class or a receiving party, regarding cooking instructions in the cooking class. The term “receiving party evaluation information” means evaluation information indicating a result of an evaluation of a receiving party by an instructor or a student of a cooking class. For example, “receiving party evaluation information” means: evaluation information indicating a result of an evaluation by an evaluation target, of the quality of an evaluation comment received from a receiving party after the evaluation target checks the evaluation comment made by the receiving party on the evaluation target; evaluation information indicating a result of an evaluation by an instructor or a student of a cooking class, of the punctuality including whether a receiving party has shown up later than a provision date and time; and the like.

The controller 26 receives, from the information processing apparatus 10 via the network 50 and the communication interface 21, for example, receiving party evaluation information on an evaluation by an instructor or a student of a cooking class, of a receiving party provided with a deliverable, regarding the above mentioned evaluation comment from the receiving party. When the input interface 23 detects an operation by the receiving party, the controller 26 outputs the received evaluation information to the output interface 24.

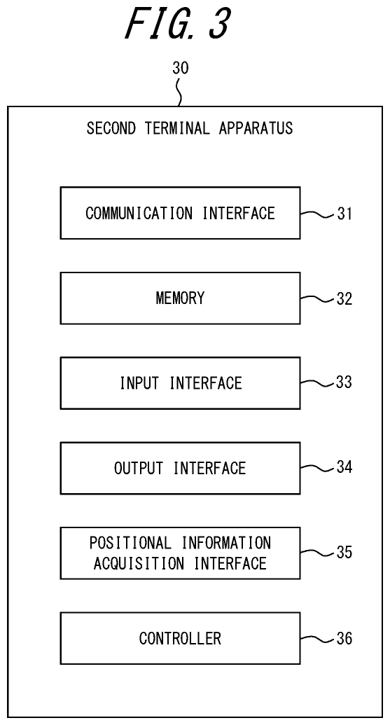

Next, referring to FIG. 3, a configuration of the second terminal apparatus 30 included in the information processing system 1 will be primarily described. FIG. 3 is a functional block diagram illustrating a schematic configuration of the second terminal apparatus 30 in FIG. 1.

As illustrated in FIG. 3, the second terminal apparatus 30 includes a communication interface 31, a memory 32, an input interface 33, an output interface 34, a positional information acquisition interface 35, and a controller 36.

The communication interface 31 includes a communication module connected to the network 50. For example, the communication interface 31 may include a communication module compliant with mobile communication standards such as the 4G and the 5G standards. In an embodiment, the second terminal apparatus 30 is connected to the network 50 via the communication interface 31. The communication interface 31 transmits and receives various information via the network 50.

The memory 32 is, for example, a semi-conductor memory, a magnetic memory, an optical memory, or the like, but is not limited to these. The memory 32 may function as, for example, a main memory, an auxiliary memory, or a cache memory. The memory 32 stores any information used in operation of the second terminal apparatus 30. For example, the memory 32 may store a system program, an application program, various types of information received by the communication interface 31, and the like. Information stored in the memory 32 may be updated with, for example, information received from the network 50 via the communication interface 31.

The input interface 33 includes at least one input interface for detecting user input to acquire input information based on an operation by a user. The input interface 23 is, for example, a physical key, a capacitive key, a touch screen integrally provided with a display of the output interface 34, a microphone for receiving audio input, or the like, but is not limited to these.

The output interface 34 includes at least one output interface for outputting information to notify the user of the information. The output interface 34 is, for example, a display for outputting the information in the form of an image, a speaker for outputting the information in the form of audio, or the like, but is not limited to these.

The positional information acquisition interface 35 includes at least one receiver compliant with a satellite positioning system. For example, the positional information acquisition interface 35 may include a GPS receiver. The positional information acquisition interface 35 acquires a measured value of the position of the second terminal apparatus 30 as positional information.

The positional information includes, for example, an address, a latitude, a longitude, an altitude, and the like. The positional information acquisition interface 35 may continuously acquire, or may periodically or non-periodically acquire the positional information for the second terminal apparatus 30.

The controller 36 includes at least one processor. The “processor” is a general purpose processor or a dedicated processor that is dedicated to specific processing in an embodiment but is not limited to these. The controller 36 is connected to each component included in the second terminal apparatus 30 so as to communicate with each component, and controls the operation of the entire second terminal apparatus 30.

When the input interface 33 detects an operation by the user as a member of staff of an operating company who requests registration of holding information, the controller 36 displays an input screen indicating items required for registration of the holding information, using the output interface 34. The items required for registration of the holding information include, for example, items such as a holding area, a start date and time, an end date and time, and a food and/or a beverage to be the theme. The controller 36 acquires input information regarding these items that the member of staff inputs by operating the input interface 33. The controller 36 transmits the acquired input information as the holding information to the information processing apparatus 10 via the communication interface 31 and the network 50.

In addition to the holding information, the controller 36 also transmits participant information on participants including an instructor and a student participating in a cooking class, to the information processing apparatus 10 via the communication interface 31 and the network 50. In this specification, “participant information” means, for example, an address of each participant, a participation start date and time, a participation end date and time, and the like. The participant information is acquired by the controller 36 by, for example, being transmitted from any terminal apparatus used by the participants to the second terminal apparatus 30.

The controller 36 receives, from the information processing apparatus 10 via the network 50 and the communication interface 31, pickup information for the vehicle 40 to pick up the participants of the cooking class, which is determined by the information processing apparatus 10 based on the participant information. In this specification, “pickup information” means, for example, a pickup location, a pickup route, a pickup date and time, and the like that are optimized, according to the participant information, for the vehicle 40 to pick up the participants. The controller 36 notifies the participants of the pickup information received from the information processing apparatus 10, as required. For example, the participants understand the pickup location, the pickup date and time, and the like of the vehicle 40 in which the cooking class is held, based on the pickup information transmitted from the second terminal apparatus 30 to any terminal apparatus used by the participants.

The controller 36 receives, from a terminal apparatus used by an instructor, for example, student evaluation information regarding cooking in a cooking class, or receiving party evaluation information regarding an evaluation comment from a receiving party provided with a deliverable. The controller 36 transmits the received evaluation information as evaluation information indicating a result of an evaluation by the instructor of another person from among the instructor and the student of the cooking class and the receiving party, to the information processing apparatus 10 via the communication interface 31 and the network 50.

The controller 36 receives, from a terminal apparatus used by a student, for example, instructor evaluation information regarding cooking instructions in a cooking class, or receiving party evaluation information regarding an evaluation comment from a receiving party provided with a deliverable. The controller 36 transmits the received evaluation information as evaluation information indicating a result of an evaluation by the student of another person from among the instructor and the student of the cooking class and the receiving party, to the information processing apparatus 10 via the communication interface 31 and the network 50.

The controller 36 receives, from the information processing apparatus 10 via the network 50 and the communication interface 31, for example, instructor evaluation information on an evaluation of the instructor by a receiving party regarding a deliverable provided from a cooking class. The controller 36 transmits the received evaluation information to a terminal apparatus used by the instructor, as required. For example, upon receiving instructor evaluation information on an evaluation of the instructor by a student regarding cooking instructions in the cooking class, from a terminal apparatus used by the student, the controller 36 may transmit the received evaluation information to the terminal apparatus used by the instructor, as required.

The controller 36 receives, from the information processing apparatus 10 via the network 50 and the communication interface 31, for example, student evaluation information on an evaluation of a student by a receiving party regarding a deliverable provided from a cooking class. The controller 36 transmits the received evaluation information to a terminal apparatus used by the student, as required. For example, upon receiving student evaluation information on an evaluation of the student by an instructor regarding cooking in the cooking class, from a terminal apparatus used by the instructor, the controller 36 may transmit the received evaluation information to the terminal apparatus used by the student, as required.

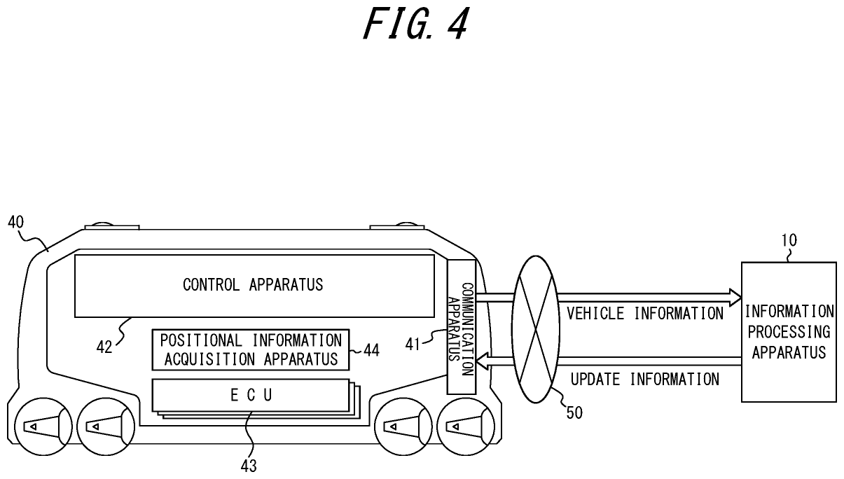

Next, referring to FIG. 4, a configuration of the vehicle 40 will be primarily described. FIG. 4 is a functional block diagram illustrating a schematic configuration of the vehicle 40 in FIG. 1.

As illustrated in FIG. 4, the vehicle 40 includes a communication apparatus 41, a control apparatus 42, a plurality of electronic control units (ECUs) 43, and a positional information acquisition apparatus 44. The communication apparatus 41, the control apparatus 42, the plurality of ECUs 43, and the positional information acquisition apparatus 44 are connected so as to communicate with each other, via a vehicle-mounted network such as Controller Area Network (CAN), or dedicated lines.

The communication apparatus 41 includes a communication module for communicating via the vehicle-mounted network or the dedicated lines. The communication apparatus 41 may include a communication module compliant with mobile communication standards such as the 4G and the 5G standards, to connect to the network 50. The vehicle 40 is connected to the network 50 via the communication apparatus 41. The communication apparatus 41 transmits and receives various information via the network 50.

The control apparatus 42 is, for example, an apparatus configured to perform vehicle control based on control information received from the information processing apparatus 10. The vehicle control is, for example, automated driving control for navigating the vehicle 40 to each pickup location, at which a corresponding participant is to be picked up, according to a pickup route based on the above mentioned pickup information determined by the information processing apparatus 10, but is not limited to this. The vehicle control may be automated driving control for navigating the vehicle 40 to a provision location, at which a deliverable obtained in a cooking class is to be provided, based on provision route information, which will be described later. The vehicle control is executed by cooperation between the control apparatus 42 and each ECU 43 or the like. The control apparatus 42 includes a communication module configured to communicate with the communication apparatus 41, each ECU 43, and the positional information acquisition apparatus 44; at least one memory configured to store a system program, an application program, and the like; and a controller that includes at least one processor configured to control operation of the entire control apparatus 42.

The control apparatus 42 receives, for example, various types of vehicle information for the vehicle 40 from each ECU 43 or the like. The vehicle information includes the speed, the acceleration, the position, the automated driving state, and the like. The control apparatus 42 transmits the vehicle information to the information processing apparatus 10 using the communication apparatus 41. The control apparatus 42 receives update information such as a system program, from the information processing apparatus 10 using the communication apparatus 41. Upon receiving control information from the information processing apparatus 10, the control apparatus 42 executes the vehicle control for the vehicle 40 based on the control information.

The plurality of ECUs 43 cooperates with the control apparatus 42 to control operation of the vehicle 40. Specifically, the plurality of ECUs 43 receives a control command based on the control information from the control apparatus 42, and controls the operation of the vehicle 40 according to the control command. For example, the plurality of ECUs 43 controls an operation amount for the vehicle 40 to be a value indicated by the control command. The plurality of ECUs 43 collects measured values of a control amount or the operation amount for the vehicle 40 from various sensors mounted in the vehicle 40 at each control timing, and transmits the measured values to the control apparatus 42.

The positional information acquisition apparatus 44 includes at least one receiver compliant with a satellite positioning system. For example, the positional information acquisition apparatus 44 may include a GPS receiver.

The positional information acquisition apparatus 44 acquires a measured value of the position of the vehicle 40 as positional information, and transmits the measured value to the control apparatus 42. The positional information includes, for example, an address, a latitude, a longitude, an altitude, a driving lane position, and the like. The positional information acquisition apparatus 44 may continuously acquire, or may periodically or non-periodically acquire the positional information for the vehicle 40.

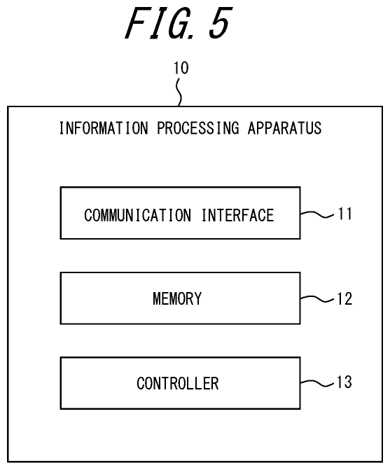

Next, referring to FIG. 5, a configuration of the information processing apparatus 10 included in the information processing system 1 will be primarily described. FIG. 5 is a functional block diagram illustrating a schematic configuration of the information processing apparatus 10 in FIG. 1.

As illustrated in FIG. 5, the information processing apparatus 10 includes a communication interface 11, a memory 12, and a controller 13.

The communication interface 11 includes a communication module connected to the network 50. For example, the communication interface 11 may include a communication module compliant with mobile communication standards such as the 4G and the 5G standards. In an embodiment, the information processing apparatus 10 is connected to the network 50 via the communication interface 11. The communication interface 11 transmits and receives various information via the network 50.

The memory 12 is, for example, a semi-conductor memory, a magnetic memory, an optical memory, or the like, but is not limited to these. The memory 12 may function as, for example, a main memory, an auxiliary memory, or a cache memory. The memory 12 stores any information used in operation of the information processing apparatus 10. For example, the memory 12 may store a system program, an application program, various types of information received by the communication interface 11, and the like. Information stored in the memory 12 may be updated with, for example, information received from the network 50 via the communication interface 11.

The controller 13 includes at least one processor. The “processor” is a general purpose processor or a dedicated processor that is dedicated to specific processing in an embodiment but is not limited to these. The controller 13 is connected to each component included in the information processing apparatus 10 so as to communicate with each component, and controls the operation of the entire information processing apparatus 10.

The controller 13 receives holding information on each cooking class to be held in the vehicle 40 from the second terminal apparatus 30 via the network 50 and the communication interface 11. The controller 13 receives reception information on each receiving party who is to be provided with a deliverable obtained in a corresponding cooking class, from each first terminal apparatus 20 via the network 50 and the communication interface 11. The controller 13 executes matching between a cooking class and a receiving party based on the holding information and the reception information that are received. The controller 13 determines provision information to be notified to the receiving party according to the result of the matching. The controller 13 transmits the determined provision information to the first terminal apparatus 20 of the receiving party related to the provision information via the communication interface 11 and the network 50.

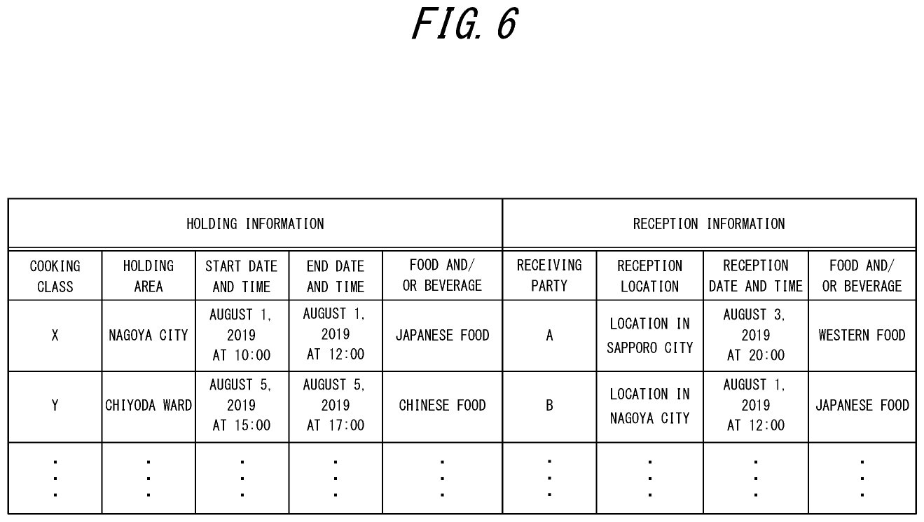

FIG. 6 is a diagram for explaining matching between a cooking class and a receiving party. Referring to FIG. 6, a matching process and a determining process for provision information executed by the controller 13 will be described in more detail.

The controller 13 acquires holding information on cooking class X to be held in the vehicle 40. According to the holding information on cooking class X, the holding area is Nagoya city. Similarly, the start date and time, and the end date and time are Aug. 1, 2019 at 10:00 and 12:00, respectively, and the food and/or beverage to be the theme of cooking class X is Japanese food. The controller 13 acquires holding information on cooking class Y to be held in the vehicle 40. According to the holding information on cooking class Y, the holding area is Chiyoda ward. Similarly, the start date and time, and the end date and time are Aug. 5, 2019 at 15:00 and 17:00, respectively, and the food and/or beverage to be the theme of cooking class Y is Chinese food. In addition to the holding information on cooking classes X and Y, the controller 13 may further acquire holding information on other cooking classes.

The controller 13 acquires reception information on receiving party A to be provided with a deliverable obtained in a cooking class. According to the reception information on receiving party A, the reception location desired by receiving party A is a predetermined location in Sapporo city. Similarly, the reception date and time desired by receiving party A is Aug. 3, 2019 at 20:00, and the food and/or beverage desired by receiving party A is Western food. The controller 13 acquires reception information on receiving party B to be provided with a deliverable obtained in a cooking class. According to the reception information on receiving party B, the reception location desired by receiving party B is a predetermined location in Nagoya city. Similarly, the reception date and time desired by receiving party B is Aug. 1, 2019 at 12:00, and the food and/or beverage desired by receiving party B is Japanese food. In addition to the reception information on receiving parties A and B, the controller 13 may further acquire reception information on other receiving parties.

In this situation, the holding area, the end date and time, and the food and/or beverage for cooking class X correspond to the reception location, the reception date and time, and the food and/or beverage for receiving party B, respectively. Therefore, the controller 13 extracts the holding information associated with cooking class X and the reception information associated with receiving party B, from the holding information on the cooking classes and the reception information on the receiving parties that are acquired, thereby executing matching between cooking class X and receiving party B.

According to the result of such matching, the controller 13 may determine the provision location regarding provision of the deliverable to be, for example, the location in Nagoya city desired by receiving party B as the reception location, or the vicinity thereof. Similarly, the controller 13 may determine the provision date and time regarding the provision of the deliverable to be, for example, Aug. 1, 2019 at 12:00, which is desired by receiving party B as the reception date and time, or the vicinity thereof. Similarly, the controller 13 may determine the food and/or beverage regarding the provision of the deliverable to be, for example, Japanese food, which is the theme of cooking class X.

The controller 13 receives participant information on participants including an instructor and a student participating in a cooking class, from the second terminal apparatus 30 via the network 50 and the communication interface 11. The controller 13 determines pickup information for the vehicle 40 to pick up the participants of the cooking class, based on the received participant information. In addition, the controller 13 determines, as provision route information, a route for navigating the vehicle 40 to the location at which a deliverable is to be provided, the location being included in the determined provision information. The controller 13 transmits the determined pickup information to the second terminal apparatus 30 and the vehicle 40 via the communication interface 11 and the network 50. The controller 13 transmits the determined provision route information along with the provision information to the vehicle 40 via the communication interface 11 and the network 50.

The controller 13 acquires evaluation information indicating a result of an evaluation by one person of another person from among the instructor and the student of the cooking class and a receiving party. For example, the controller 13 receives instructor evaluation information or student evaluation information regarding the deliverable provided from the cooking class, from the first terminal apparatus 20 of the receiving party via the network 50 and the communication interface 11. For example, the controller 13 receives student evaluation information regarding cooking in the cooking class, or receiving party evaluation information regarding an evaluation comment from the receiving party provided with the deliverable, from a terminal apparatus used by the instructor via the second terminal apparatus 30, the network 50, and the communication interface 11. For example, the controller 13 receives instructor evaluation information regarding cooking instructions in the cooking class, or receiving party evaluation information regarding an evaluation comment from the receiving party provided with the deliverable, from a terminal apparatus used by the student via the second terminal apparatus 30, the network 50, and the communication interface 11.

The controller 13 may determine, for example, a food and/or a beverage to be the theme of the cooking class included in the holding information, based on the acquired student evaluation information. For example, when the controller 13 determines that an evaluation rank in the acquired student evaluation information is lower than a predetermined rank, the controller 13 may determine the food and/or beverage to be the theme of the cooking class, to be a food and/or a beverage that is easier to cook. For example, when the controller 13 determines that the evaluation rank in the acquired student evaluation information is equal to or higher than the predetermined rank, the controller 13 may determine the food and/or beverage to be the theme of the cooking class, to be a food and/or a beverage that is more complicated to cook. Similarly, the controller 13 may determine the food and/or beverage to be the theme of the cooking class by associating an evaluation score, an evaluation comment, and the like in the acquired student evaluation information, with the difficulty of cooking the food and/or beverage.

The controller 13 may determine, for example, the amount of a tuition fee to be paid by the student to the operating company for taking the cooking class, based on the acquired student evaluation information. For example, when the controller 13 determines that the evaluation rank in the acquired student evaluation information is lower than the predetermined rank, the controller 13 may determine the amount of the tuition fee to be higher than a predetermined amount. For example, when the controller 13 determines that the evaluation rank in the acquired student evaluation information is equal to or higher than the predetermined rank, the controller 13 may determine the amount of the tuition fee to be equal to or lower than the predetermined amount. Similarly, the controller 13 may determine the amount of the tuition fee to be paid by the student to the operating company, by associating the evaluation score, the evaluation comment, and the like in the acquired student evaluation information, with the amount of the tuition fee.

The controller 13 may determine, for example, the amount of a payment to be obtained by the instructor from the operating company for giving the cooking instructions in the cooking class, based on the acquired instructor evaluation information. For example, when the controller 13 determines that an evaluation rank in the acquired instructor evaluation information is lower than a predetermined rank, the controller 13 may determine the amount of the payment to be lower than a predetermined amount. For example, when the controller 13 determines that the evaluation rank in the acquired instructor evaluation information is equal to or higher than the predetermined rank, the controller 13 may determine the amount of the payment to be equal to or higher than the predetermined amount. Similarly, the controller 13 may determine the amount of the payment to be obtained by the instructor from the operating company, by associating an evaluation score, an evaluation comment, and the like in the acquired instructor evaluation information, with the amount of the payment.

The controller 13 may determine, for example, the amount of a reception fee to be paid by the receiving party to the operating company for being provided with the deliverable obtained in the cooking class, based on the acquired receiving party evaluation information. For example, when the controller 13 determines that an evaluation rank in the acquired receiving party evaluation information is lower than a predetermined rank, the controller 13 may determine the amount of the reception fee to be higher than a predetermined amount. For example, when the controller 13 determines that the evaluation rank in the acquired receiving party evaluation information is equal to or higher than the predetermined rank, the controller 13 may determine the amount of the reception fee to be equal to or lower than the predetermined amount. Similarly, the controller 13 may determine the amount of the reception fee to be paid by the receiving party to the operating company, by associating an evaluation score, an evaluation comment, and the like in the acquired receiving party evaluation information, with the amount of the reception fee.

The controller 13 transmits all of the above mentioned determination information determined based on the evaluation information, to the second terminal apparatus 30 via the communication interface 11 and the network 50. In addition, the controller 13 transmits information regarding the amount of the reception fee to be paid by the receiving party to the operating company, which is determined based on the receiving party evaluation information, to the first terminal apparatus 20 via the communication interface 11 and the network 50.

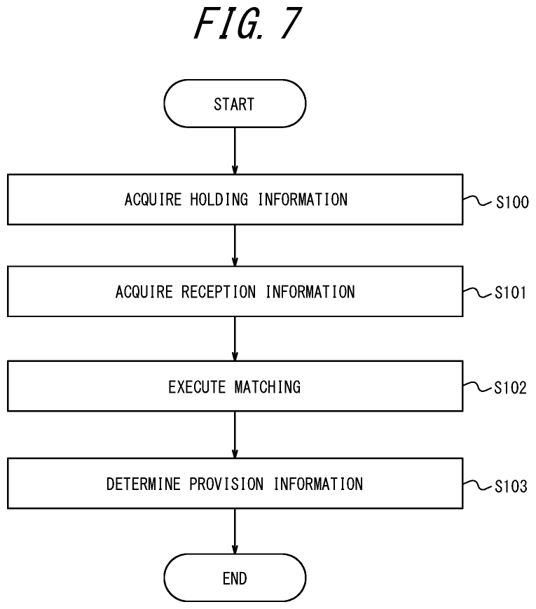

Next, an information processing method executed by the controller 13 of the information processing apparatus 10 according to an embodiment will be described, referring to FIGS. 7 to 13. FIG. 7 is a flowchart for explaining a first example of the information processing method executed by the information processing apparatus 10 in FIG. 1.

In step S100, the controller 13 acquires holding information on each cooking class to be held in the vehicle 40.

In step S101, the controller 13 acquires reception information on each receiving party who is to be provided with a deliverable obtained in a corresponding cooking class.

In step S102, the controller 13 executes matching between a cooking class and a receiving party based on the holding information acquired in step S100 and the reception information acquired in step S101.

In step S103, the controller 13 determines provision information to be notified to the receiving party according to the result of the matching in step S102.

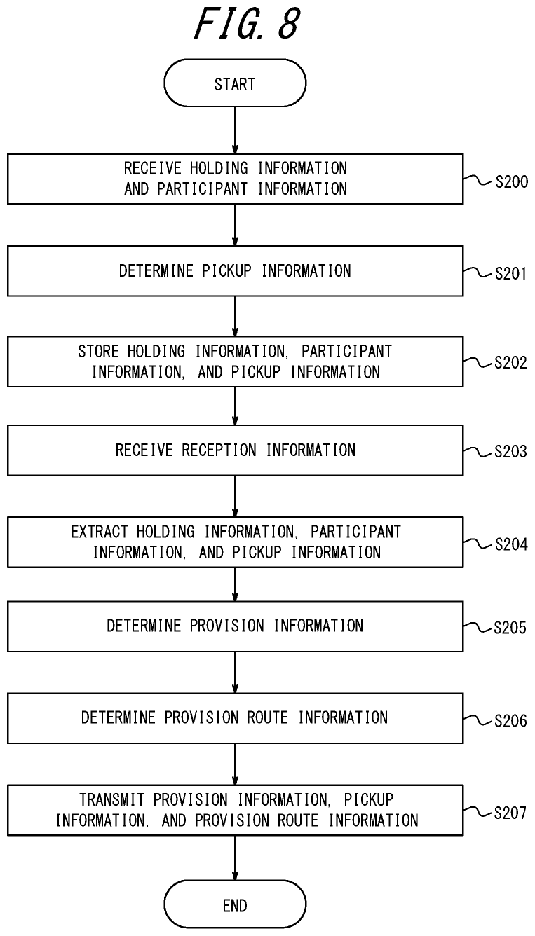

FIG. 8 is a flowchart for explaining a second example of the information processing method executed by the information processing apparatus 10 in FIG. 1. The flowchart given in FIG. 8 illustrates the control flow of the flowchart given in FIG. 7 in more detail. The flowchart in FIG. 8 illustrates a control flow performed when execution of the matching between the cooking class and the receiving party who is to be provided with the deliverable is triggered by transmittal of the reception information to the information processing apparatus 10 by the receiving party using the first terminal apparatus 20.

In step S200, the controller 13 receives the holding information on each cooking class to be held in the vehicle 40 and participant information related to the holding information, from the second terminal apparatus 30 via the network 50 and the communication interface 11.

In step S201, the controller 13 determines pickup information for the vehicle 40 to pick up participants including an instructor and a student of each cooking class, based on the participant information on the participants.

In step S202, the controller 13 stores the holding information and the participant information received in step S200 and the pickup information determined in step S201, in the memory 12.

In step S203, the controller 13 receives the reception information from the first terminal apparatus 20 of the receiving party via the network 50 and the communication interface 11.

In step S204, the controller 13 executes the matching by extracting the holding information, the participant information, and the pickup information corresponding to the reception information received in step S203, from the holding information, the participant information, and the pickup information associated with the cooking classes.

In step S205, the controller 13 determines the provision information to be notified to the receiving party according to the result of the matching in step S204.

In step S206, the controller 13 determines, as provision route information, a route for navigating the vehicle 40 to the location at which the deliverable is to be provided, the location being included in the provision information determined in step S205.

In step S207, the controller 13 transmits the provision information determined in step S205 to the first terminal apparatus 20 and the vehicle 40 via the communication interface 11 and the network 50. The controller 13 transmits the pickup information determined in step S201 to the second terminal apparatus 30 and the vehicle 40 via the communication interface 11 and the network 50. The controller 13 transmits the provision route information determined in step S206 to the vehicle 40 via the communication interface 11 and the network 50.

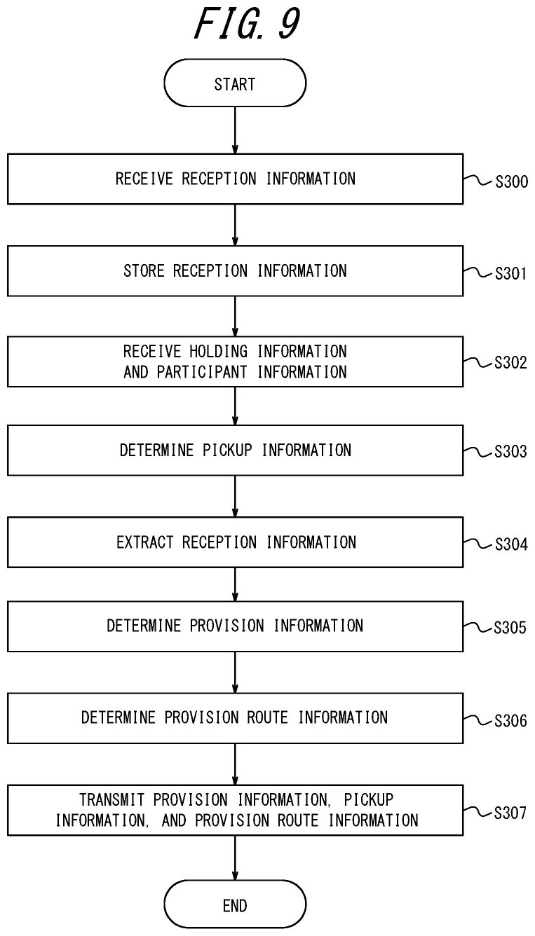

FIG. 9 is a flowchart for explaining a third example of the information processing method executed by the information processing apparatus 10 in FIG. 1. The flowchart given in FIG. 9 illustrates the control flow of the flowchart given in FIG. 7 in more detail. The flowchart in FIG. 9 illustrates a control flow performed when execution of the matching between the cooking class and the receiving party is triggered by transmittal of the holding information to the information processing apparatus 10 by a member of staff of an operating company that operates the cooking class using the second terminal apparatus 30.

In step S300, the controller 13 receives the reception information on each receiving party who is to be provided with the deliverable obtained in the corresponding cooking class, from the first terminal apparatus 20 of each receiving party via the network 50 and the communication interface 11.

In step S301, the controller 13 stores the reception information received in step S300 in the memory 12.

In step S302, the controller 13 receives the holding information on the cooking class to be held in the vehicle 40 and participant information related to the holding information, from the second terminal apparatus 30 via the network 50 and the communication interface 11.

In step S303, the controller 13 determines pickup information for the vehicle 40 to pick up participants including an instructor and a student of the cooking class, based on the participant information on the participants.

In step S304, the controller 13 executes the matching by extracting the reception information corresponding to the holding information and the participant information related to the holding information that are received in step S302, from the reception information associated with each receiving party.

In step S305, the controller 13 determines the provision information to be notified to the receiving parties according to the result of the matching in step S304.

In step S306, the controller 13 determines, as provision route information, a route for navigating the vehicle 40 to the location at which the deliverable is to be provided, the location being included in the provision information determined in step S305.

In step S307, the controller 13 transmits the provision information determined in step S305 to the first terminal apparatus 20 and the vehicle 40 via the communication interface 11 and the network 50. The controller 13 transmits the pickup information determined in the step S303 to the second terminal apparatus 30 and the vehicle 40 via the communication interface 11 and the network 50. The controller 13 transmits the provision route information determined in step S306 to the vehicle 40 via the communication interface 11 and the network 50.

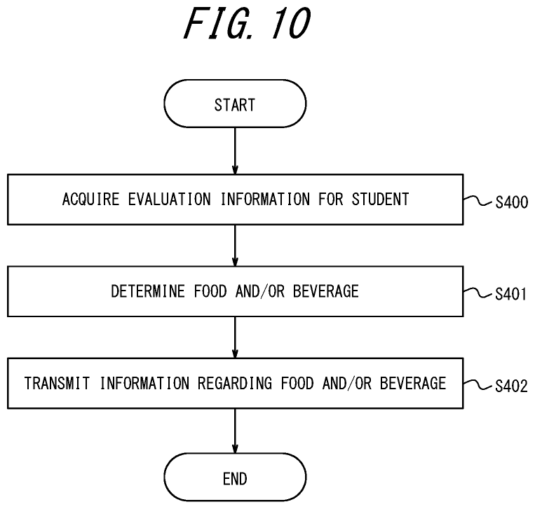

FIG. 10 is a flowchart for explaining a fourth example of the information processing method executed by the information processing apparatus 10 in FIG. 1. The flowchart given in FIG. 10 illustrates a control flow that is executed when the information processing apparatus 10 receives evaluation information indicating a result of an evaluation of the student by the instructor from the second terminal apparatus 30 via the network 50 and the communication interface 11, for example, after the cooking class has been held. Alternatively, the flowchart given in FIG. 10 illustrates a control flow that is executed when the information processing apparatus 10 receives evaluation information indicating a result of an evaluation of the student by the receiving party from the first terminal apparatus 20 via the network 50 and the communication interface 11, for example, after the deliverable has been consumed.

In step S400, the controller 13 acquires the evaluation information indicating the result of the evaluation of the student by the instructor of the cooking class or the receiving party.

In step S401, the controller 13 determines a food and/or a beverage to be the theme of the cooking class included in the holding information, based on the student evaluation information acquired in step S400.

In step S402, the controller 13 transmits information regarding the food and/or beverage determined in step S401 to the second terminal apparatus 30 via the communication interface 11 and the network 50. Thereafter, the controller 36 of the second terminal apparatus 30 may transmit, as the theme of the cooking class to be held next time, the information regarding the food and/or beverage received from the information processing apparatus 10 to a terminal apparatus used by the instructor and a terminal apparatus used by the student, as required.

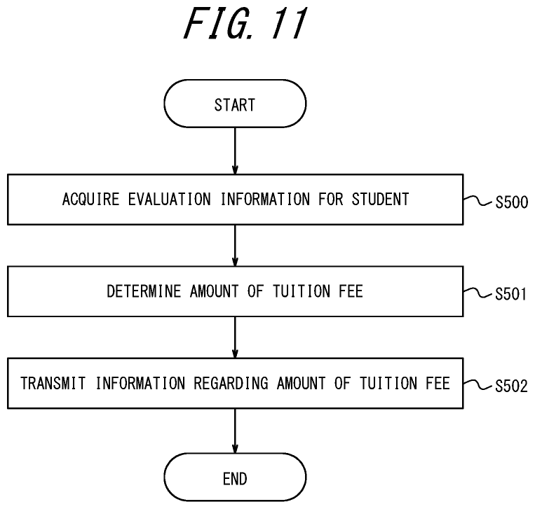

FIG. 11 is a flowchart for explaining a fifth example of the information processing method executed by the information processing apparatus 10 in FIG. 1. The flowchart given in FIG. 11 illustrates a control flow that is executed when the information processing apparatus 10 receives evaluation information indicating a result of an evaluation of the student by the instructor from the second terminal apparatus 30 via the network 50 and the communication interface 11, for example, after the cooking class has been held. Alternatively, the flowchart given in FIG. 11 illustrates a control flow that is executed when the information processing apparatus 10 receives evaluation information indicating a result of an evaluation of the student by the receiving party from the first terminal apparatus 20 via the network 50 and the communication interface 11, for example, after the deliverable has been consumed.

In step S500, the controller 13 acquires the evaluation information indicating the result of the evaluation of the student by the instructor of the cooking class or the receiving party.

In step S501, the controller 13 determines the amount of a tuition fee to be paid by the student to the operating company for taking the cooking class, based on the student evaluation information acquired in step S500.

In step S502, the controller 13 transmits information regarding the amount of the tuition fee determined in step S501 to the second terminal apparatus 30 via the communication interface 11 and the network 50. Thereafter, the controller 36 of the second terminal apparatus 30 may transmit the information regarding the amount of the tuition fee received from the information processing apparatus 10 to a terminal apparatus used by the student, as required.

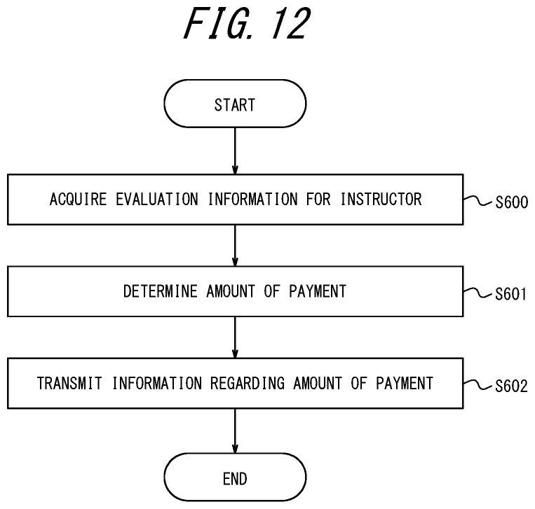

FIG. 12 is a flowchart for explaining a sixth example of the information processing method executed by the information processing apparatus 10 in FIG. 1. The flowchart given in FIG. 12 illustrates a control flow that is executed when the information processing apparatus 10 receives evaluation information indicating a result of an evaluation of the instructor by the student from the second terminal apparatus 30 via the network 50 and the communication interface 11, for example, after the cooking class has been held. Alternatively, the flowchart given in FIG. 12 illustrates a control flow that is executed when the information processing apparatus 10 receives evaluation information indicating a result of an evaluation of the instructor by the receiving party from the first terminal apparatus 20 via the network 50 and the communication interface 11, for example, after the deliverable has been consumed.

In step S600, the controller 13 acquires the evaluation information indicating the result of the evaluation of the instructor by the student of the cooking class or the receiving party.

In step S601, the controller 13 determines the amount of a payment to be obtained by the instructor from the operating company for giving cooking instructions in the cooking class, based on the instructor evaluation information acquired in step S600.

In step S602, the controller 13 transmits information regarding the amount of the payment determined in step S601 to the second terminal apparatus 30 via the communication interface 11 and the network 50. Thereafter, the controller 36 of the second terminal apparatus 30 may transmit the information regarding the amount of the payment received from the information processing apparatus 10 to a terminal apparatus used by the instructor, as required.

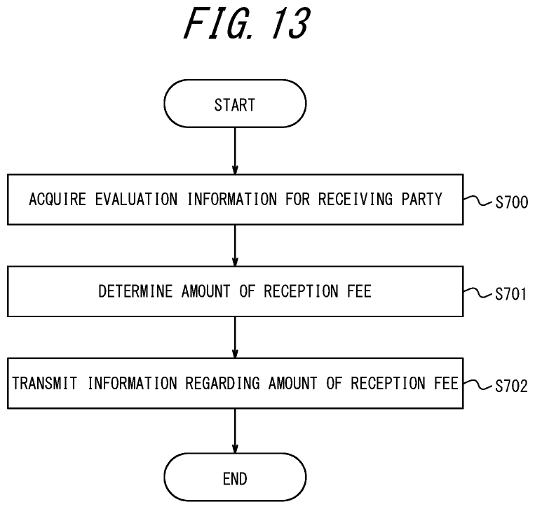

FIG. 13 is a flowchart for explaining a seventh example of the information processing method executed by the information processing apparatus 10 in FIG. 1. The flowchart given in FIG. 13 illustrates a control flow that is executed when the information processing apparatus 10 receives evaluation information indicating a result of an evaluation of the receiving party by the instructor or the student from the second terminal apparatus 30 via the network 50 and the communication interface 11, for example, after the instructor or the student has checked an evaluation comment from the receiving party.

In step S700, the controller 13 acquires the evaluation information indicating the result of the evaluation of the receiving party by the instructor or the student of the cooking class.

In step S701, the controller 13 determines the amount of a reception fee to be paid by the receiving party to the operating company for being provided with the deliverable obtained in the cooking class, based on the receiving party evaluation information acquired in step S700.

In step S702, the controller 13 transmits information regarding the amount of the reception fee determined in step S701 to the first terminal apparatus 20 and the second terminal apparatus 30 via the communication interface 11 and the network 50.

According to the above mentioned embodiment, since the vehicle 40 is used for holding a cooking class and providing a deliverable, the provision location and the provision date and time at which the deliverable is to be provided can be easily adjusted depending on the moving time and the moving place of the vehicle 40. That is, the limitations on the provision location and the provision date and time at which the deliverable is to be provided to a receiving party are sufficiently relaxed, and thus the potential for matching between the cooking class and the receiving party is improved. As a result, the mechanism for providing the deliverable to the receiving party becomes effective with respect to the cooking class held in the vehicle 40. In this way, the service regarding the cooking class and the service regarding the provision of the deliverable are successively associated, thereby increasing the certainty that ingredients prepared in advance in the cooking class and cooked by a student will be consumed as the deliverable, by an instructor, the student, and/or the receiving party. Therefore, the utilization efficiency of the ingredients is improved, and the possibility that the ingredients will be discarded wastefully is reduced.

As in the control flow illustrated in FIG. 8, the execution, by the information processing apparatus 10, of the matching between the cooking class and the receiving party is triggered by transmittal of the reception information to the information processing apparatus 10 by the receiving party using the first terminal apparatus 20, thereby selecting in real time the most appropriate cooking class in accordance with the reception information on the receiving party from the plurality of cooking classes stored in the information processing apparatus 10. Therefore, the convenience for the receiving party who uses the information processing system 1 which includes the information processing apparatus 10 is improved. As a result, the satisfaction of the receiving party is improved, and the mechanism for providing the deliverable to the receiving party becomes effective.

As in the control flow of FIG. 9, the execution, by the information processing apparatus 10, of the matching between the cooking class and the receiving party is triggered by transmittal of the holding information to the information processing apparatus 10 by the member of staff of the operating company that operates the cooking class using the second terminal apparatus 30, thereby selecting in real time the most appropriate receiving party in accordance with the holding information on the cooking class from the plurality of receiving parties stored in the information processing apparatus 10. Therefore, the convenience for the operating company that uses the information processing system 1 which includes the information processing apparatus 10 is improved. The possibility that the ingredients will be discarded wastefully is reduced, and also the reception fee is paid by the receiving party, to thereby improve the profit obtained by operation of the cooking class.

By acquiring the evaluation information indicating the result of the evaluation by one person of another person from among the instructor and the student of the cooking class and the receiving party, the information processing apparatus 10 can determine various information related to the evaluation information for the instructor, the student, and the receiving party. Utilizing the various determined information in the service regarding the cooking class and the service regarding the provision of the deliverable improves the attractiveness of these services. Thus, the frequency of use of these services by the instructor, the student, and the receiving party is increased. As a result, the profit obtained by the operation of the cooking class is improved.

The information processing apparatus 10 determines the food and/or beverage to be the theme of the cooking class included in the holding information based on the acquired student evaluation information, thereby enabling the operating company, which receives notification of the determined food and/or beverage, to hold the cooking class most appropriate for the cooking level of the student. The student who takes such a cooking class can also receive cooking instructions most appropriate for the cooking level of the student. Therefore, the attractiveness of the service regarding the cooking class is improved, and the frequency of use of the service by the student is increased.

The information processing apparatus 10 determines the amount of the tuition fee to be paid by the student to the operating company for taking the cooking class, based on the acquired student evaluation information, thereby enabling the operating company, which receives notification of the determined amount of the tuition fee, to present to the student, the tuition fee most appropriate for the cooking level of the student. The student who takes the cooking class also attempts to improve his/her cooking level in order to lower the tuition fee, and thus his/her motivation for cooking is improved. Therefore, the attractiveness of the service regarding the cooking class is improved, and the frequency of use of the service by the student is increased.

The information processing apparatus 10 determines the amount of the payment to be obtained by the instructor from the operating company for giving the cooking instructions in the cooking class, based on the acquired instructor evaluation information, thereby enabling the operating company, which receives notification of the determined amount of the payment, to pay to the instructor, the payment most appropriate for the instruction level of the instructor. The instructor who gives the cooking instructions in the cooking class also attempts to improve his/her instruction level in order to raise the amount of the payment, and thus his/her motivation for giving the cooking instructions is improved. Therefore, the attractiveness of the service regarding the cooking class is improved, and the frequency of use of the service by the instructor is increased.

The information processing apparatus 10 determines the amount of the reception fee to be paid by the receiving party to the operating company for being provided with the deliverable obtained in the cooking class, based on the acquired receiving party evaluation information, thereby enabling the operating company, which receives notification of the determined amount of the reception fee, to present to the receiving party, for example, the reception fee most appropriate for the contents of the evaluation comment by the receiving party. The receiving party provided with the deliverable also seriously attempts to make the evaluation comment for the instructor or the student regarding the deliverable, in order to lower the reception fee. Thus, the quality of the evaluation comment made is improved, and the service regarding the cooking class and the service regarding the provision of the deliverable that are provided in series become more attractive. Therefore, the frequency of use of these services by the instructor, the student, and the receiving party is increased.

The information processing apparatus 10 determines the pickup information based on the participant information, thereby enabling the vehicle 40 to pick up the instructor and student at the most appropriate times and places via the most appropriate route, for example, with automated driving. In addition, the information processing apparatus 10 determines the route for navigating the vehicle 40 to the determined location at which the deliverable is to be provided, thereby enabling the vehicle 40 to move to the location at which the deliverable is to be provided via the most appropriate route, for example, with automated driving.

The cooking class is held in the vehicle 40, thereby ensuring the privacy of the participants participating in the cooking classes. Thus, the psychological resistance of the participants to participation in the cooking class is suppressed.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each configuration, each step, or the like, may be rearranged without logical inconsistency, and a plurality of configurations, steps, or the like can be combined into one, or divided.

For example, in the embodiment described above, one or some processing operations executed in the information processing apparatus 10 may be executed in the first terminal apparatus 20 and/or the second terminal apparatus 30. At least one or some processing operations executed in the first terminal apparatus 20 and/or the second terminal apparatus 30 may be executed in the information processing apparatus 10.

For example, a configuration in which a general purpose electronic device such as a smart phone, a computer, or the like may be caused to function as the information processing apparatus 10 according to the embodiment described above is possible. Specifically, a program in which processes for realizing the functions of the information processing apparatus 10 or the like according to the embodiment are written may be stored in a memory of the electronic device, and the program may be read and executed by a processor of the electronic device. Accordingly, the disclosure according to an embodiment can also be implemented as a program executable by a processor. Alternatively, the disclosure according to an embodiment can also be implemented as a non-transitory computer readable medium storing a program executable by a single processor or a plurality of processors to cause the information processing apparatus 10 or the like according to the embodiment to execute the functions. It is to be understood that these are also included within the scope of the present disclosure.

For example, in the embodiment described above, the vehicle 40 has been described as an automated driving vehicle, but is not limited thereto. The vehicle 40 may not be an automated driving vehicle. In a vehicle 40, which is not an automated driving vehicle, routes based on the pickup information and the provision route information that are received may be output to the driver, and driving along each route may be assisted.

For example, the information processing apparatus 10 described in the above embodiment may be mounted in the vehicle 40. In this case, the information processing apparatus 10 may directly perform information communication with the vehicle 40 without using the network 50. The information processing system 1 may not include the first terminal apparatus 20 and the second terminal apparatus 30, and the information processing apparatus 10 mounted in the vehicle 40 may execute the above described acquisition and notification of the information using any input interface and output interface provided in the vehicle 40. An ECU 43 mounted in the vehicle 40 may function as the controller 13.

For example, in the embodiment described above, the cooking class has been described as being hosted by the operating company, but is not limited thereto. The cooking class may be hosted by at least one of the participants including the instructor and the student participating in the cooking class. In this case, at least one of the participants including the instructor and the student may provide the holding information on each cooking class to be held in the vehicle 40, from a terminal apparatus used by the at least one participant to the information processing apparatus 10. That is, the second terminal apparatus 30 may be a terminal apparatus used by a participant. In this case, the second terminal apparatus 30 serving as the terminal apparatus used by the participant may acquire the address of the participant as the participant information from the input interface 33, and transmit the participant information to the information processing apparatus 10 via the communication interface 31 and the network 50. The second terminal apparatus 30 is not limited to this, and may transmit the positional information for the second terminal apparatus 30 acquired by the positional information acquisition interface 35 as the participant information to the information processing apparatus 10. The information processing apparatus 10 may determine the pickup information for the vehicle 40 to pick up the participants of the cooking class, based on the received positional information for the second terminal apparatus 30.

For example, in the embodiment described above, the first terminal apparatus 20 has been described as acquiring the reception location desired by the receiving party as the reception information from the input interface 23, and transmitting the reception information to the information processing apparatus 10 via the communication interface 21 and the network 50, but is not limited thereto. The first terminal apparatus 20 may transmit the positional information for the first terminal apparatus 20 acquired by the positional information acquisition interface 25 as the reception information to the information processing apparatus 10. The information processing apparatus 10 may determine the provision information including the location at which the deliverable is to be provided, based on the received positional information for the first terminal apparatus 20.

For example, in the embodiment described above, the cooking class may be held after the information processing apparatus 10 executes the matching, or the information processing apparatus 10 may execute the matching in real time while the cooking class is being held.

For example, in the embodiment described above, the information processing apparatus 10 has been described as executing the matching by extracting the specific holding information and the specific reception information, but is not limited thereto. For example, in a case in which there is a plurality of candidate cooking classes for the matching, the information processing apparatus 10 may transmit candidate information as a list to the first terminal apparatus 20 of the receiving party. The receiving party may select the holding information on a specific cooking class which the receiving party ultimately desires, while checking a candidate list displayed on the output interface 24 of the first terminal apparatus 20.

For example, in the embodiment described above, the information processing apparatus 10 has been described as executing the matching by extracting the specific holding information and the specific reception information, but is not limited thereto. For example, in a case in which there is a plurality of candidate receiving parties for the matching, the information processing apparatus 10 may transmit candidate information as a list to the second terminal apparatus 30. The member of staff of the operating company may select the reception information on a specific receiving party whom the member of staff ultimately desires, while checking a candidate list displayed on the output interface 34 of the second terminal apparatus 30. Similarly, the instructor or the student of the cooking class may select the reception information on a specific receiving party whom the instructor or the student ultimately desires, based on the candidate information transmitted from the second terminal apparatus 30 to his/her terminal apparatus.

1. An information processing apparatus comprising a controller configured to:
acquire holding information on a cooking class to be held in a vehicle and reception information on a receiving party who is to be provided with a deliverable obtained in the cooking class;
execute matching between the cooking class and the receiving party based on the holding information and the reception information that are acquired; and
determine provision information to be notified to the receiving party according to a result of the matching.

2. The information processing apparatus according to claim 1, wherein, upon receiving the reception information from a first terminal apparatus of the receiving party, the controller executes the matching by extracting the holding information corresponding to the received reception information, and transmits the determined provision information to the first terminal apparatus.

3. The information processing apparatus according to claim 1, wherein, upon receiving the holding information from a second terminal apparatus which is separate from a first terminal apparatus of the receiving party, the controller executes the matching by extracting the reception information corresponding to the received holding information, and transmits the determined provision information to the first terminal apparatus.

4. The information processing apparatus according to claim 1, wherein the controller is configured to acquire evaluation information indicating a result of an evaluation by one person of another person from among an instructor and a student of the cooking class and the receiving party.

5. The information processing apparatus according to claim 4, wherein
the evaluation information indicates a result of an evaluation of the student by the instructor or the receiving party, and
the controller is configured to determine a food and/or a beverage to be a theme of the cooking class included in the holding information, based on the acquired evaluation information for the student.

6. The information processing apparatus according to claim 1, wherein the controller is configured to determine pickup information for the vehicle to pick up participants including an instructor and a student of the cooking class, based on participant information on the participants, and to determine a route for navigating the vehicle to a location at which the deliverable is to be provided, the location being included in the determined provision information.

7. A vehicle equipped with the information processing apparatus according to claim 1.

8. An information processing system comprising:
the information processing apparatus according to claim 1;
a first terminal apparatus of the receiving party, the first terminal apparatus being configured to transmit the reception information to the information processing apparatus; and
a second terminal apparatus which is separate from the first terminal apparatus of the receiving party, the second terminal apparatus being configured to transmit the holding information to the information processing apparatus.

9. An information processing method executed by an information processing apparatus, the information processing method comprising:
acquiring holding information on a cooking class to be held in a vehicle;
acquiring reception information on a receiving party who is to be provided with a deliverable obtained in the cooking class;
executing matching between the cooking class and the receiving party based on the holding information and the reception information that are acquired; and
determining provision information to be notified to the receiving party according to a result of the matching.

10. The information processing method according to claim 9, wherein, when the acquiring of the reception information receives the reception information from a first terminal apparatus of the receiving party, the executing of the matching executes the matching by extracting the holding information corresponding to the received reception information,
the information processing method further comprising transmitting the provision information determined by the determining of the provision information, to the first terminal apparatus.

11. The information processing method according to claim 9, wherein, when the acquiring of the holding information receives the holding information from a second terminal apparatus which is separate from a first terminal apparatus of the receiving party, the executing of the matching executes the matching by extracting the reception information corresponding to the received holding information,
the information processing method further comprising transmitting the provision information determined by the determining of the provision information, to the first terminal apparatus.

12. The information processing method according to claim 9, further comprising acquiring evaluation information indicating a result of an evaluation by one person of another person from among an instructor and a student of the cooking class and the receiving party.

13. The information processing method according to claim 12, wherein the evaluation information indicates a result of an evaluation of the student by the instructor or the receiving party,
the information processing method further comprising determining a food and/or a beverage to be a theme of the cooking class included in the holding information, based on the evaluation information for the student acquired by the acquiring of the evaluation information.

14. The information processing method according to claim 9, further comprising:
determining pickup information for the vehicle to pick up participants including an instructor and a student of the cooking class, based on participant information on the participants; and
determining a route for navigating the vehicle to a location at which the deliverable is to be provided, the location being included in the provision information determined by the determining of the provision information.

15. A non-transitory computer readable medium storing a program executable by one or more processors to cause an information processing apparatus to execute functions, the functions comprising:
acquiring holding information on a cooking class to be held in a vehicle;
acquiring reception information on a receiving party who is to be provided with a deliverable obtained in the cooking class;
executing matching between the cooking class and the receiving party based on the holding information and the reception information that are acquired; and
determining provision information to be notified to the receiving party according to a result of the matching.

16. The non-transitory computer readable medium according to claim 15, wherein the acquiring of the reception information comprises receiving the reception information from a first terminal apparatus of the receiving party, and the executing of the matching comprises executing the matching by extracting the holding information corresponding to the received reception information,
the functions further comprising transmitting the provision information determined by the determining of the provision information, to the first terminal apparatus.

17. The non-transitory computer readable medium according to claim 15, wherein the acquiring of the holding information comprises receiving the holding information from a second terminal apparatus which is separate from a first terminal apparatus of the receiving party, and the executing of the matching comprises executing the matching by extracting the reception information corresponding to the received holding information,
the functions further comprising transmitting the provision information determined by the determining of the provision information, to the first terminal apparatus.

18. The non-transitory computer readable medium according to claim 15, the functions further comprising acquiring evaluation information indicating a result of an evaluation by one person of another person from among an instructor and a student of the cooking class and the receiving party.

19. The non-transitory computer readable medium according to claim 18, wherein the evaluation information indicates a result of an evaluation of the student by the instructor or the receiving party,
the functions further comprising determining a food and/or a beverage to be a theme of the cooking class included in the holding information, based on the evaluation information for the student acquired by the acquiring of the evaluation information.

20. The non-transitory computer readable medium according to claim 15, the functions further comprising:
determining pickup information for the vehicle to pick up participants including an instructor and a student of the cooking class, based on participant information on the participants; and
determining a route for navigating the vehicle to a location at which the deliverable is to be provided, the location being included in the provision information determined by the determining of the provision information.
